(19) United States
(12) Patent Application Publication
(10) Pub. No.: US 2007/0175648 A1
(43) Pub. Date: Aug. 2, 2007

(54) Improvement to metallic cross sections for the manufacture of housing for electrical panels

(76) Inventor: Melquisedec Francisquini, Vila Suzana (BR)

Correspondence Address: WILLIAM J. SAPONE;COLEMAN SUDOL SAPONE P.C., 714 COLORADO AVENUE, BRIDGE PORT, CT, 06605, US

(21) Appl. No.: 10/551,111

(22) PCT Filed: Apr. 1, 2004
(86) PCT No.: PCT/BR04/00048

§ 371 Date: Sep. 5, 2006

(30) Foreign Application Priority Data
Apr. 3, 2003 (BR) 0301083-0

(51) Int. Cl. H02G 3/08

(52) U.S. Cl. 174/50

(57) ABSTRACT

Especially developed for the assembly of structures which are normally used in the most varied of cabinet types, these are also known as electrical panels, which in reality are cabinets with side closing doors to house a very large variety of electrical and electronic components and devices, encompassing a cross section (104) which on its exterior constitutes the means of support for the enclosures and accessories, whilst that on the inside, the same structure configures the uprights for the assembly of the electrical and electronic devices.

### FIELD OF THE INVENTION

More particularly the current invention refers to a singular consolidation to the geometry of a metallic cross section especially developed for the assembly of structures which are normally used in the most varied of cabinet types, these are also known as electrical panels, which in reality are cabinets with side closing doors to house a very large variety of electrical and electronic components and devices.

Condition of this Technique

As it is known from those who are capable in this technique, currently there are different types of electrical panels, also known as frames, cabinets, or closets, designed to house diverse electrical and electronic components and devices in the most varied of activities, also including telephony.

Therefore under the different conditions of electrical distribution or assembly of electrical and electronic components and devices the use of a closet, cabinet or panel is extremely important.

Although currently there are a very large variety of electrical panels, normally these are metallic boxes with the appropriate closing device, including one or more doors depending on its size. Such closing devices including the doors are normally manufactured from appropriately thin metallic sheets. In this manner all electrical panels have an internal metallic cross section structure. This structure as the name itself says constitutes the means for supporting the parts which make up the external walls out of stamped metal sheets, as well as constituting the means by which the doors are assembled and supported as well as their respective hinges, also, this same structure, although on the inside, also configures the equipment necessary for the distribution and assembly of the different electrical and electronic devices and components.

It is logically fundamental that any electrical panel has in its interior a substantially strong structure to characterize a cabinet or closet housing the internal components to be installed.

Currently there are different types of structures, all of them made from metallic cross sections, which in most of the cases are formed by sheet steel folding presses, this makes the production process difficult as well as presenting a few technical restrictions.

On the other hand there are also other types of metallic cross sections formed in extruders, such as those shown in the following documents: PI 8.406.283—published on Jul. 12, 1984—layout panel for a distribution cabinet; DE 19536950—published on Apr. 10, 1995—with reference to a cross section structure; PI 9.509.594—published on Sep. 30, 1997—frame for a distribution cabinet; PI 9.713.114—published on Jun. 11, 1997—frame with a back structure and a structure covered with an extruded sheet; PI 9.713.518-6—published on Jun. 11, 1997—frame for a distribution cabinet panel; PI 9.509.578—published on Dec. 23, 1997—frame for a distribution cabinet; PI 9.708.041—published on Jul. 27, 1999—distribution cabinet with a panel structure; PI 9.712.778-7—published on Oct. 19, 1999—frame cross section for a cross section structure of a distribution cabinet; PI 9.712.779-5—published on Oct. 19, 1999—distribution cabinet; BR PI 0.201.155—published on Mar. 3, 2002—cross section for making up electrical panel frames; and BR PI 0.202.231—published on Jun. 6, 2002—improvement to metallic cross section for making up structures to assemble electric panels.

Therefore in most of the abovementioned cross sections and others are generally of the tubular type, and are therefore consequently closed, defining a tubular core with one or more extended sides. The tubular part and extensions have holes of different shapes, not only for fastening the components as well as electrical and electronic devices, but also other details which are an integral part of the unit, such as doors and hinges.

It is important to highlight that the current electrical panels, cabinets or closets are also manufactured to affect two TYPES of applications, commercially defined as: INDOORS type (sheltered use) and OUTDOORS type (unsheltered use—exposed to the elements). The difference between these two types basically consists of the DEGREE OF MECHANICAL PROTECTION AND SEALING of the side covers and doors; consequently, we may say that the one defined as the outdoor type has a higher degree of mechanical protection and sealing.

Traditionally the indoor type is suited to be used in a closed environment protected from the elements, while the other type defined as the outdoor type is ideal to be used in open air location, as is the case for example, with some cabinets used in the telephony sector. Nevertheless the outdoor type due to it higher degree of sealing is also used advantageously in closed environments, with harsh environments, not only due to the presence of suspended pollutants in the air but also due to the presence of humidity, as is the case, for example, in industry, environments processing various products, notably in the chemical sector, industrial kitchens and other similar locations.

Inconveniences of the Techniques Conditions

Currently there exists as has already been said innumerable cross sections to assemble the structures and in most cases the structural effect obtained is really satisfactory, nevertheless, as far as seals are concerned special techniques have to be carried out as to its application, as well as presenting complicating industrial execution, seeing that, as it happens, for example, in the cross section as described in the previously mentioned document the PI 8.406.283—when the frame for the distribution cabinet as published in Jul. 12, 1984, the self same is used exclusively to assemble indoor electrical panels.

Only to better explain the state of the technique, we present in our attached FIG. 30, which corresponds to FIG. 13 of the PI 8.406.283, where a transversal cut can be seen highlighting the cross section used and, this case, typically shows a critical problem which serves as standard example with reference to the sealing between the internal environment of the cabinet and the external environment.

In FIG. 30 we note that the cross section is of the type as defined with a tubular core (10), square, with two vertically opposed extensions (12-15). The tubular part of the square section and that of the extensions have rows of holes and cutouts (20-21-23-51) of different shapes and dimensions, not only for fastening and assembly of the components as well as internal electrical and electronic equipment, as well as other external components, which are an integral part of the set, such as the hinges on the doors, closing panels and/or others.

Still in relation to the attached FIG. 30, it does well to note that the holes and openings (20-21-23-51) are distributed on the four sides of the tubular core (10), consequently different points of communication are set up between cabinet's internal and external environments. In this manner the sealing afforded by the cross section's construction is totally destroyed and, with this, it makes the use of the structure's application unviable when it is to be used as an outdoor cabinet.

On the other hand still in relation to the same FIG. 30, it is noted that the adopted geometry for the construction of the cross section allows for the limited use of sealing components (72), notably those used on the doors and closing panels. Still such sealing (72), along general lines is compromised by the holes (20-21-23-51).

On the other hand, taking into consideration the geometry of the abovementioned cross section, the seals (72) is of the cord type, which may be applied in different ways, by gluing or by installing material applied directly to the closing panel or door, and with this generating other disadvantages, especially the elevated cost and, still sealing will always be an integral part of the closing panel or door and, due to the flexibility of these parts, the sealing pressure is not always uniform. Another problem, which has been, noted is the eventual damage to such seals its repair requires the changing of the closing panel or door.

Therefore in summarizing we can say that the inconveniences of the cross sections under the conditions of the technique are generated as a result of the adopted geometries for these as well as by the different openings applied to its walls and, with this, the objectives are not achieved by the set to service the condition of its use of the outdoor type.

Solution for the Condition of the Technique

To resolve the above inconveniences, the Applicant has designed a cross section as described and upheld in document BR PI 202.231, published on Jun. 6, 2002 under the same title and with a new transversal geometry especially developed to simultaneously service the assembly of electrical panel structures of the indoor and outdoor, inclusively with a number of technical and practical, among those which are highlighted are:

a) this cross section presents a core in a square shape format, where the two opposed uprights are extended in the form of wings, each of them including a right angle fold and also the tube itself or tubular core places one of the uprights facing the inside of the cabinet, where only its two adjacent sides are punched through by rows of openings for fastening and distributing the electrical components, whilst the two opposed sides of the same tubular core, those facing the outside of the cabinet, are completely closed and free of any openings, therefore, only one of its sides include a folded loop forming a third perpendicular wing in relation to the said side, with which the part of the cross section which faces the outside of the cabinet counts on at least three wings and two ends folded at right angles, consequently they form three different anchorage points for the different devices used in the cabinet's of electrical panel final assembly, such as: enclosures and doors;

b) the cross section's outside is completely sealed in relation to the inside, this sealing off is naturally obtained with the cross section's own transversal geometry in conjunction with the extrusion details, that is, if we diagonally divide the cross section exactly on the tubular core, one side or the inside of the cabinet is defined by an upright with two adjacent walls, both of them with holes to assemble the electrical equipment inside the cabinet; whilst on the other side the other upright and its two adjacent walls are completely free from holes or openings, consequently there is an isolation or natural sealing due to the geometry of the cross section itself, making the internal environment of the cabinet isolated in relation to the external environment, consequently in this first descriptive phase, we may say that the same cross section advantageously services the assembly conditions of the electrical panels of the indoor and out door type;

c) the external wings have been strategically positioned, two of which have had their ends folded at right angles, which allows for type “a” trimmings which in reality is a type of rubber cross section for static use and, under this condition, both the door seals as well as the side enclosures are fitted into place directly onto the structure's profiled perimeter, characterizing sealing points completely different to the conventional cabinets, inclusively the rubber cross section affords other advantages, that is its insertion is done through simple fitting and, consequently this speeds up the entire assembly process and also in the case of maintenance, one just has to pull the one apart and fit the other, this can be done very quickly without interrupting the cabinet's operation;

d) thanks to the transversal geometry of the BR PI 202.231 cross section, this has made a new technical effect possible of extreme importance, that is, all the sides of the assembled structure are symmetrically equal, this in a way favors the interlinking of one structure to another on any of its sides, including the top and bottom, consequently, the current cross section allows the make up of modular structures which can grow or diminish at the desired moment; and

e) the three external wings combine to allow as has already been said for the fastening of the different components, such as: enclosing panels, doors (hinges), sealing rubber cross section and/or others, being that, still, an important detail is that the geometry of set of wings which besides significantly increasing the mechanical resistance of the cross section, also in a way favors the mechanical linkage between one structure and another on any one of its sides thus completing its advantageous characteristics, including the unit's modularity.

First New Technical Effect of the PI 202.231

A symmetrically combined geometry between the exterior and interior of the cabinet. Thus taking into consideration that the cross section in question presents a defined part or core just like a central core of a square tube, the adopted geometry was designed in such a way that one part (walls) of the core could offer a degree of perfect sealing in relation to the other side, that is, considering that the core is a square tube and considering a diagonal divisionary line, we have one of its uprights and its respective walls facing the inside of the cabinet, whilst the other upright and its respective walls remain facing the outside of the cabinet. In this manner the walls facing the inside of the cabinet have rows of holes and cut outs with differing shapes and sizes, for fastening and assembling the internal electrical and electronic components and devices. This does not happen with the other two walls facing the outside of the cabinet, as both are void of any openings, consequently, the natural sealing integrity of the tubular core is maintained in the current cross section.

Second New Technical Effect of the PI 202.231.

Attributes, special characteristics to the upright facing the outside, which is opposite to the internal upright. This external upright in a general way constitutes one of the most important points of the improvement in question and its constructive variations. In this way this external upright was extended into an assembly wing. This wing in a general manner may have a double or triple wall, and the wing itself may face the outside preferably at angles of 90° and within a radius of 270° limited by the two adjacent walls of the said external upright. This wall may be punched by rows of openings with different shapes and sizes, thus forming a number of fastening points which, when added to the fact that the said wing is passable to be faced at different angles, permitting it to service different technical requirements for the assembly of external components, such as: mounting of doors, mounting of panels, assembly of accessories for interlinking between two cabinets and/or others.

As can be noted the said external wing stiffens the cross section beyond that which constitutes a completely isolated point inside the cabinet and thus does not interfere in the natural sealing obtained with the cross sectioning of the cross section, that is, the sealing integrity between the internal and external environments of the cabinet is maintained untouched thus offering a means so that the current profile may be used simultaneously in the assembly of both indoor and outdoor cabinets.

Third New Technical Effect of the PI 202.231

Create other strategically positioned wings, which are natural extensions of both the adjacent walls of the internal upright, in such a manner that, even the said wings may also have its free ends folded perpendicularly either outwardly or inwardly and, with this, the different assembly points are formed as has already been said, for “a” type sealing and other types of seals.

These complementary wings, depending on the applied folding angles applied to its extremities, are set as details for different applications, that is, let us suppose that one of the wings has its end perpendicularly folded outwardly and that this cross section is positioned in the cabinet's upper of lower part. Under this condition the said wing would form a panel lice frame for support of the bottom or top of the cabinet, thus eliminating the use of fastening and supporting complements of such parts of the cabinet, being that, even when necessary, the said wing would furnish conditions so that a complementary compartment is configured in the lower part of the cabinet.

Objective not Achieved by the PI 202.231.

As can be noted the P.I. 202.231 shows a profile and some variations which have competed to definitely resolve the inconveniences of the techniques condition, seeing that it services the outdoor applications (that is, that which demands a higher degree of requirements) in a better construction concept and at a significantly lower manufacturing cost to the existing standards on the market, thus approaching the cost of the indoor models. Nevertheless what has been achieved in comparison to the indoor model costs was an approximation and not a comparison, that is because the outdoor servicing applications have a few more requirements that, which besides the addition of the necessary material, makes the construction process a little more difficult and this consequently adds to the final cost of the set.

Therefore the P.I. 202.231 cross section became economically unviable for simpler applications where the technical requirement levels are far lower, as in this case the ideal would be the use of a substantially lighter cross section and, consequently, with a smaller and more simplified geometry, in such a manner that at the end its cost may be lower in relation to the P.I. 202.231 cross section.

### OBJECTIVES OF THE INVENTION

Lay down other improvements which are characterized by the fact of defining new geometric shapes, nevertheless utilizing the wing assembly system as presented by P.I. 202.231 of Jun. 6, 2002 and, with this, making use of its main advantages, especially its imperviousness, where the internal environment is mechanically isolated from the external environment, as well as the reinforcing which results in an excellent stability and mechanical resistance.

Another objective of the invention is to anticipate a cross section with a cooperative transversal geometry so as to guarantee an excellent quality of the cross section's surface treatment, such as: paintwork, phosphation and others, being that this objective is reached by the fact that the cross section, in a first construction version does not include the superimposed metallic parts, except only for the closing stretch which, in reality is that mounting wing, which is positioned between the two opposite corners of the cross section. These two opposite sides are made up of stretches of sheet folded into a “U” shape, forming two equal shoulders at right angles which, as already has been said, has its walls apart, giving it an ideal internal configuration for the different surface treatments and, also, these same shoulders give the ideal means to improve the structural effect even more, increasing the stability of the cross section, as well as these shoulders configuring complementary surfaces which compete to form supports with ideal surface areas to mount the side and back enclosures, also this assembly condition favors the insertion of the sealing components.

Another objective of the invention is the consolidation of a cross section whose geometry is defined by a substantially simpler arrangement than the P.I. 202.231, consequently, this resulted in a cross section with a substantially simpler industrial manufacturing possibility, as initially the cross section phases were minimized, as well as the geometrical perimeter of the of the cross section was considerably reduced, consequently, a notable reduction in weight per linear meter occurred and with this the final cost of the product also underwent an equally accentuated reduction, arriving at an ideal cross section for simpler applications.

### DRAWING DESCRIPTIONS

To better understand the current Invention, the following detailed description of it is made, making references to the attached documents, where:

FIG. 1A represents a view of a completely closed electrical panel from an exemplified perspective and made with the current profile;

FIG. 1B shows another view in perspective of the same electrical panel, but with its door open;

FIG. 2 this is an exploded view of the electrical panel shown in the previous figures, highlighting the structure obtained with the current cross section;

FIG. 3 this shows a view from a perspective of a structure obtained with the cross section in question;

FIG. 4 shows a transversal section of the current profile according to a preferred constructive version;

FIG. 5 illustrates a view of a transversal section of a cabinet obtained with the current profile;

FIG. 6 shows a partial and amplified perspective of the structure shown in FIG. 3;

FIGS. from 7 to 9 are seen with details A, B, C and D amplified and indicated in FIG. 5;

FIG. 10 is a perspective showing two structures side by side as obtained with the current cross section;

FIGS. from 11 to 14 are seen showing that the structures obtained with the current cross section may be interlinked with each other on any one of its symmetrical sides;

FIGS. from 15 to 29 are seen highlighting the constructive variations of the current cross section; and

FIG. 30 is a drawing of a cross section as described in document PI 8.406.283.

### DETAILED DESCRIPTION OF THE INVENTION

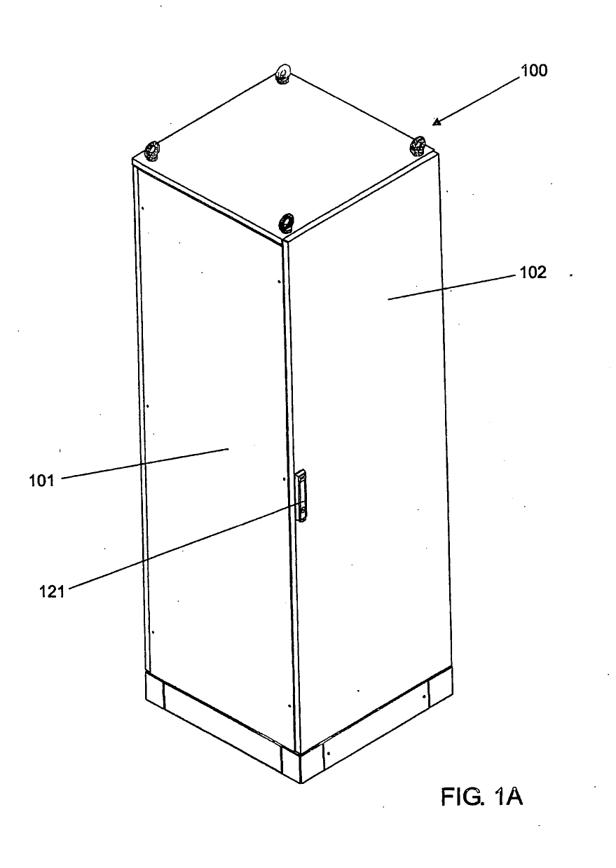

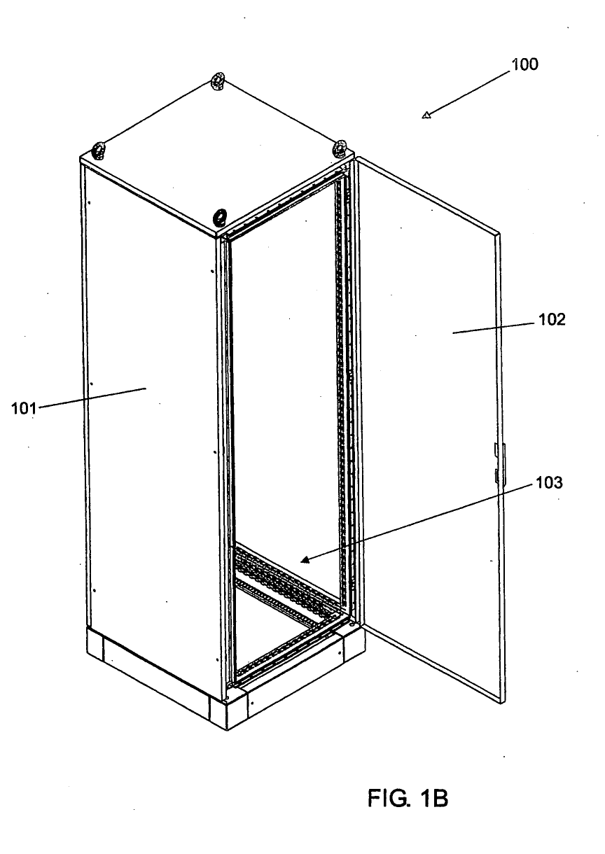

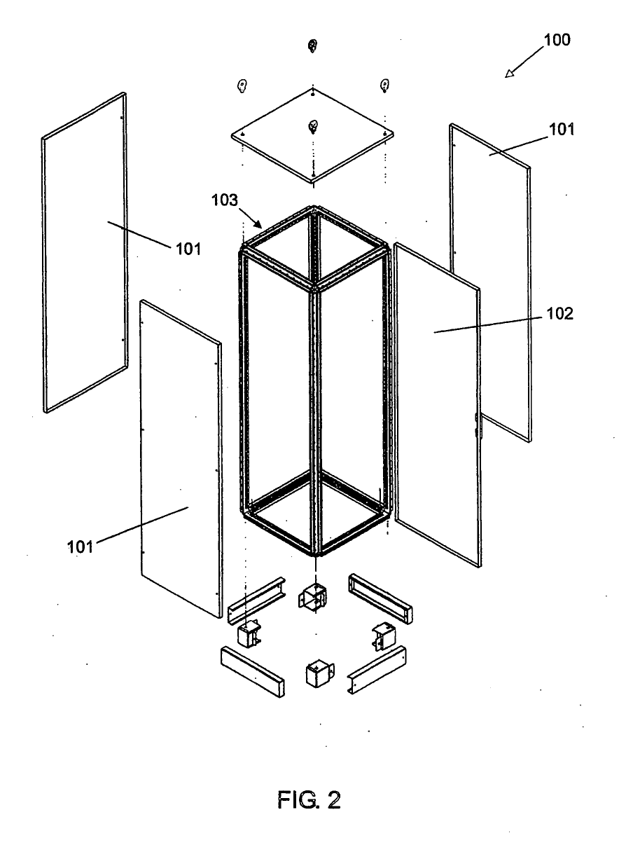

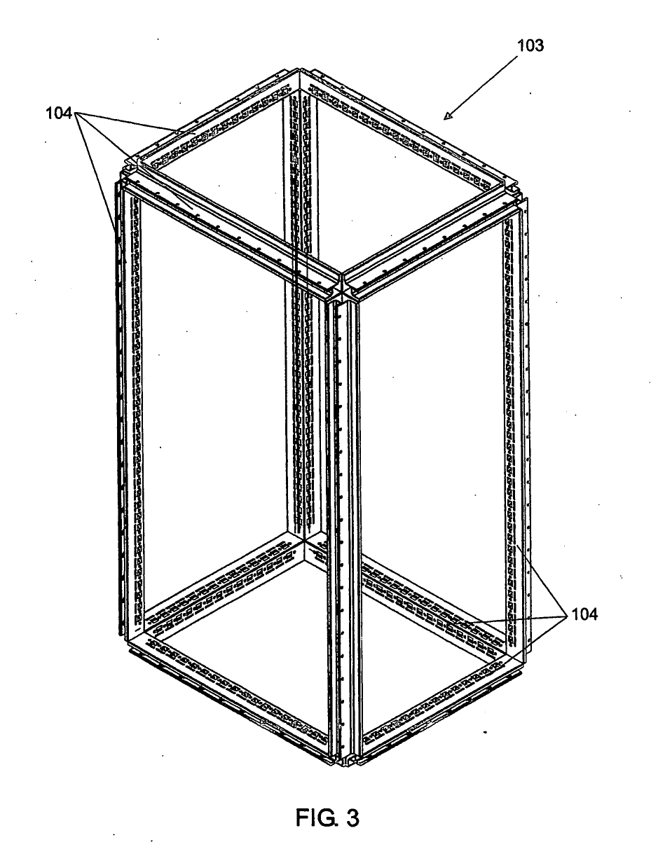

According to these illustrations and its details, the current improved cross section, was particularly developed to assemble indoor electrical cabinets, closets or panels (100) generically illustrated in FIGS. 1A, 1B and 2, where it can be seen that it is shown in the shape of a metallic box with side enclosures (101), including one or more hinged doors (102), depending on its size. Such enclosures including the doors are normally made from substantially thin metallic sheets. In this manner all electrical panels have an internal structure of metallic cross sections (103), also illustrated in FIG. 3, through which one can see the structure as the name itself says, constitutes the means of support for the parts which make up the external walls of folded sheets, as well as constituting the means for support and assembly of the doors and respective hinges as well as the other accessories which have not been illustrated, being that, even this self same structure, although on the inside; also configures the necessary uprights for the distribution and assembly of the different electrical and electronic devices and components.

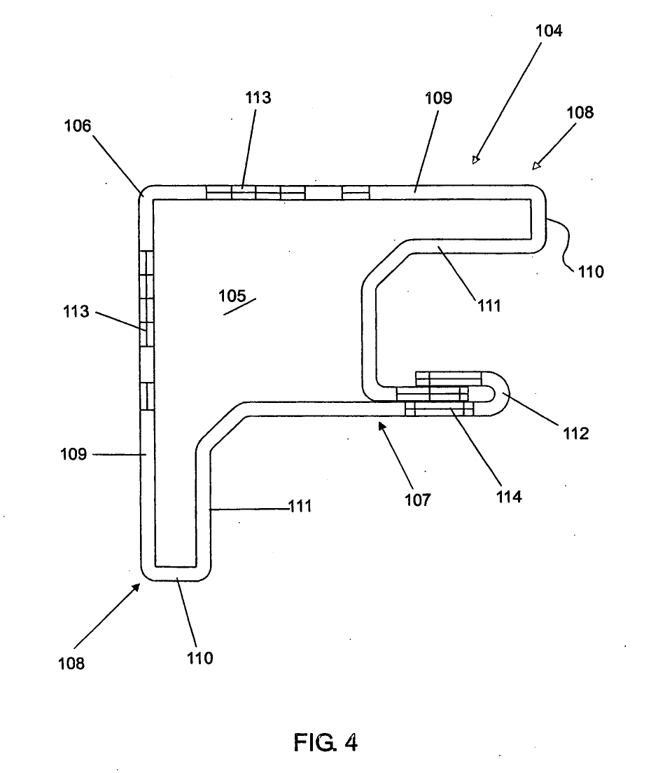

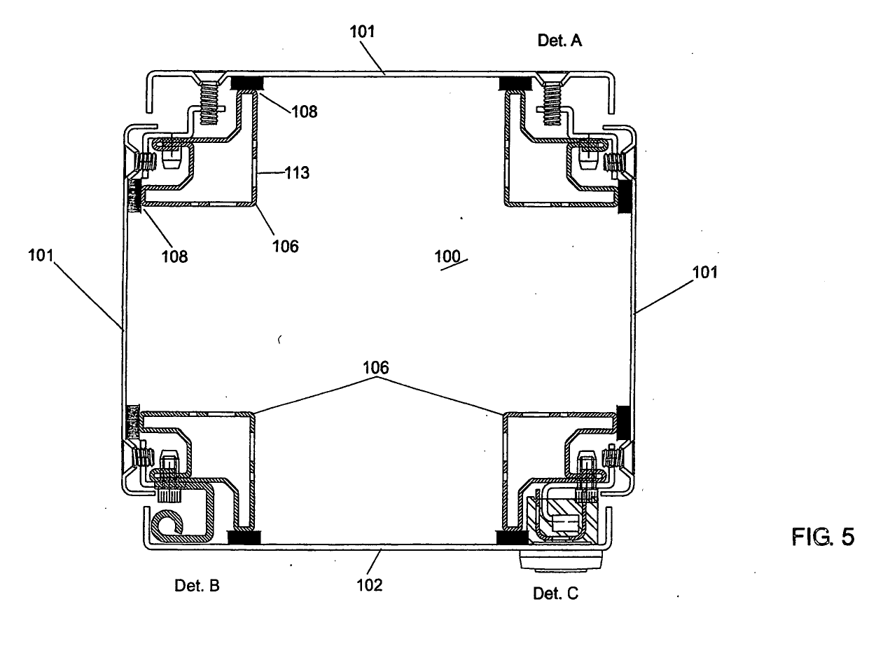

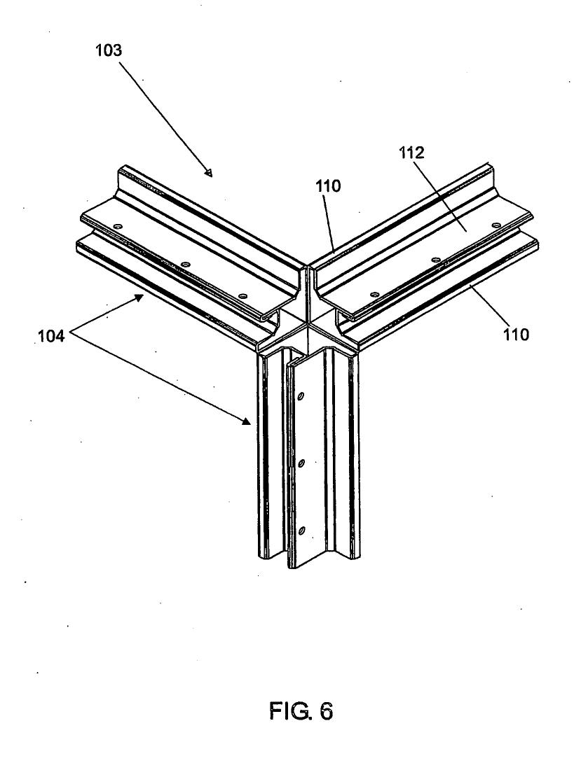

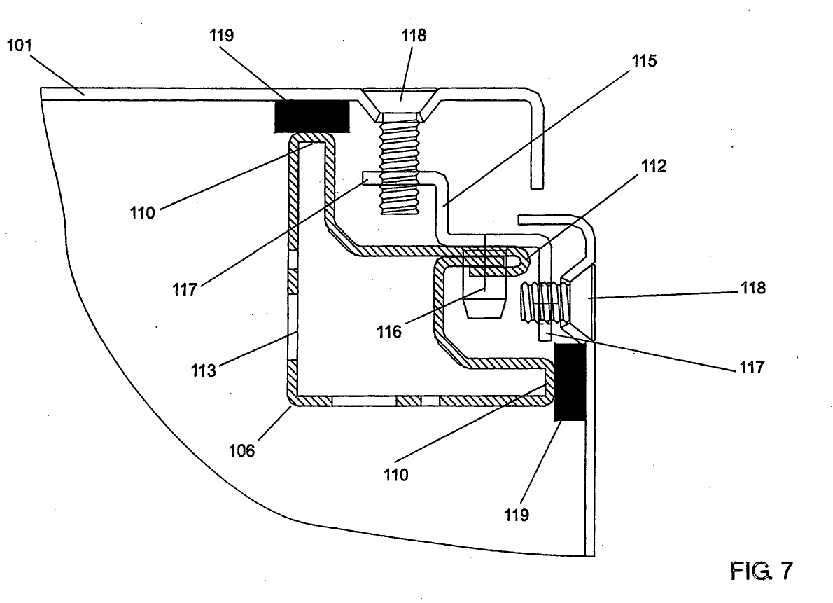

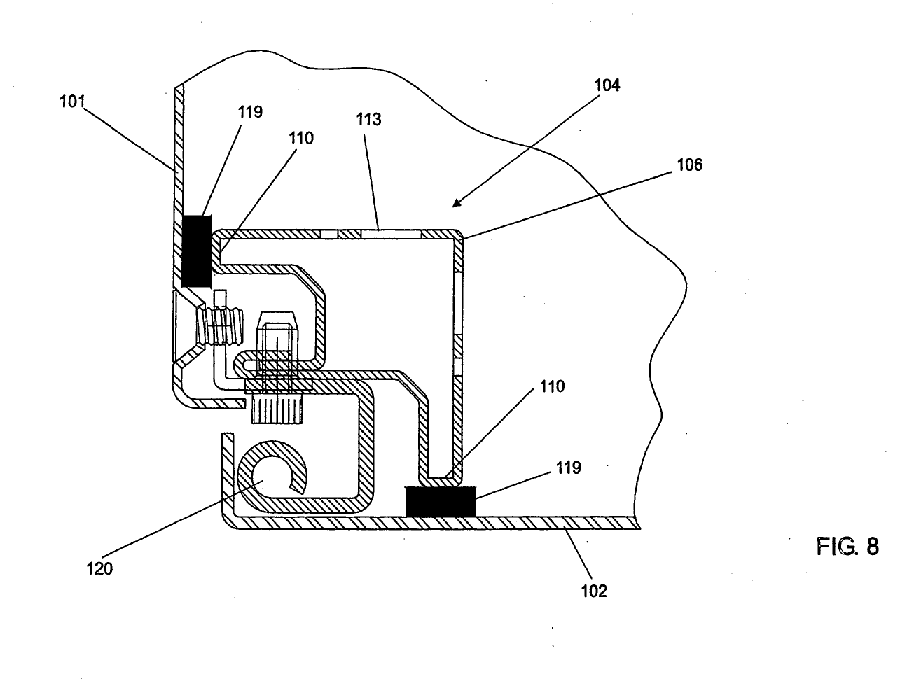

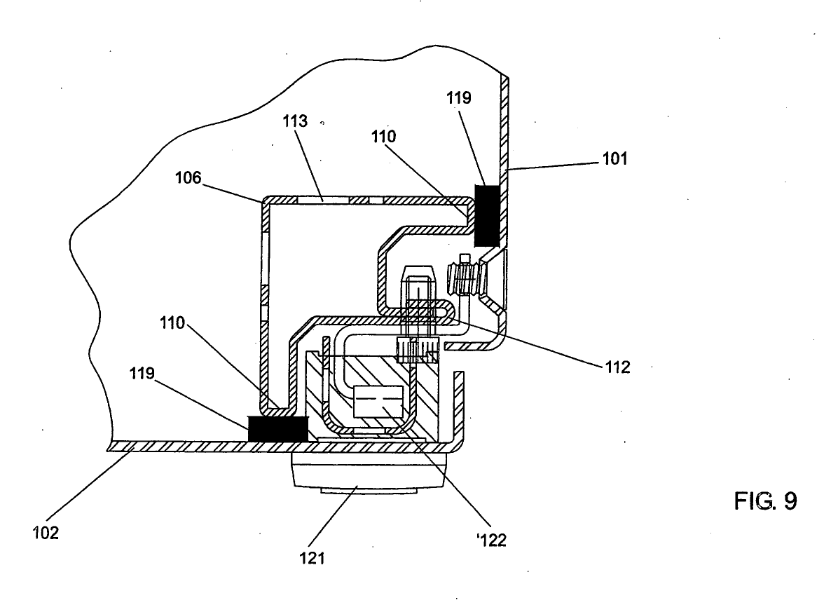

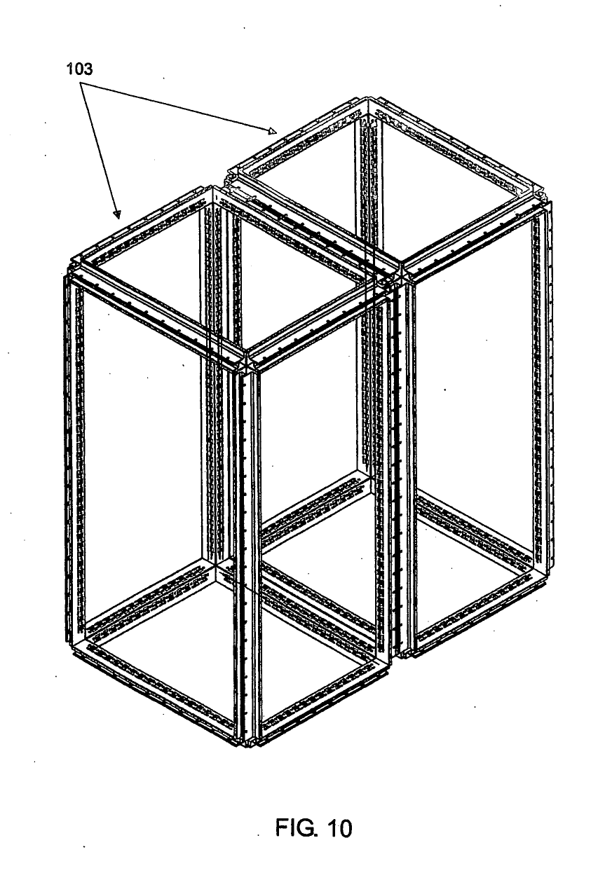

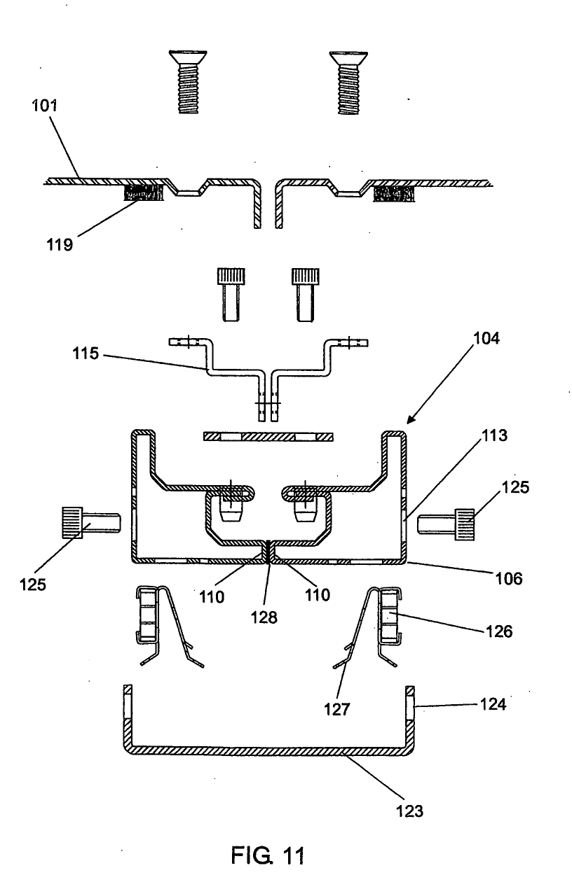

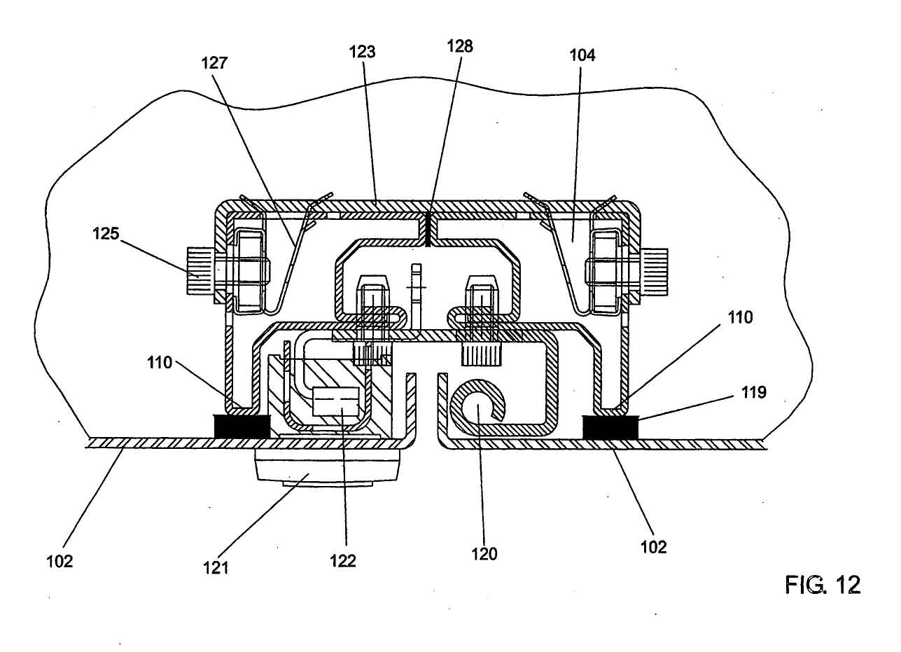

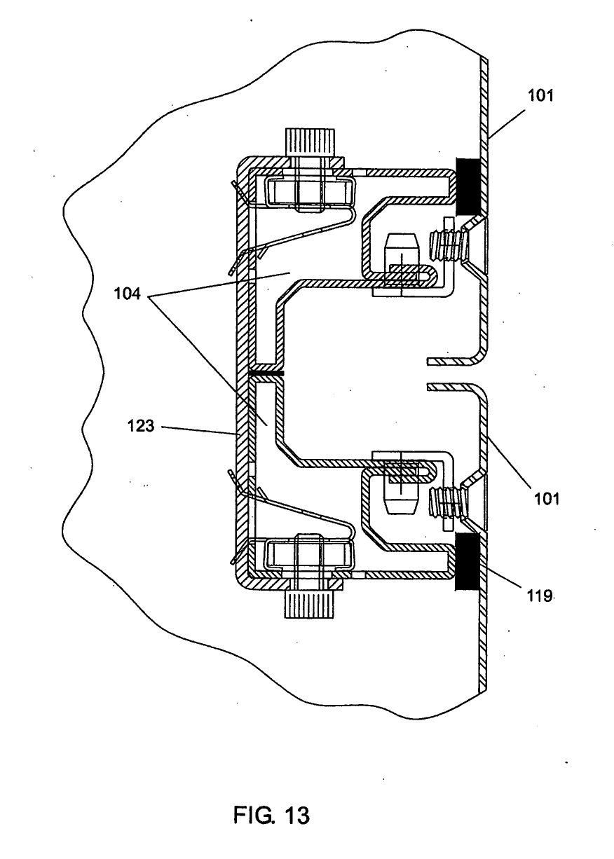

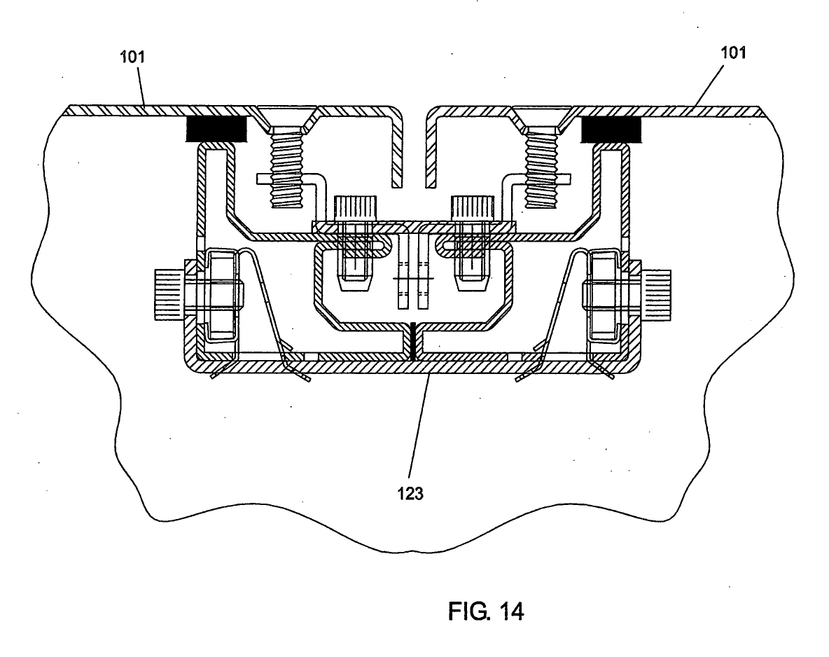

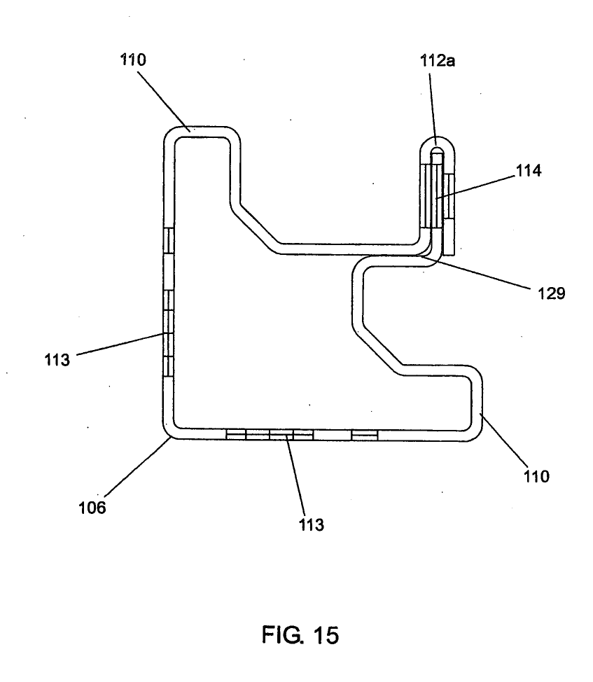

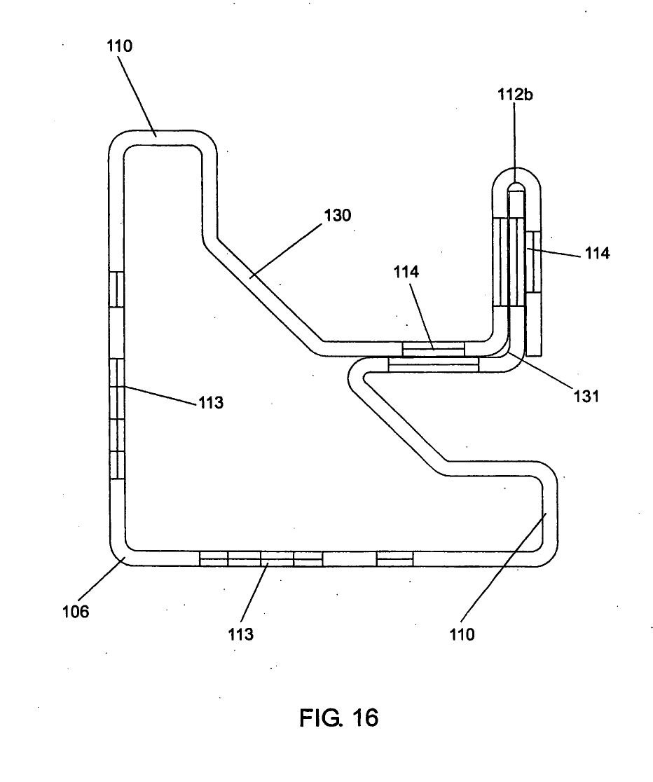

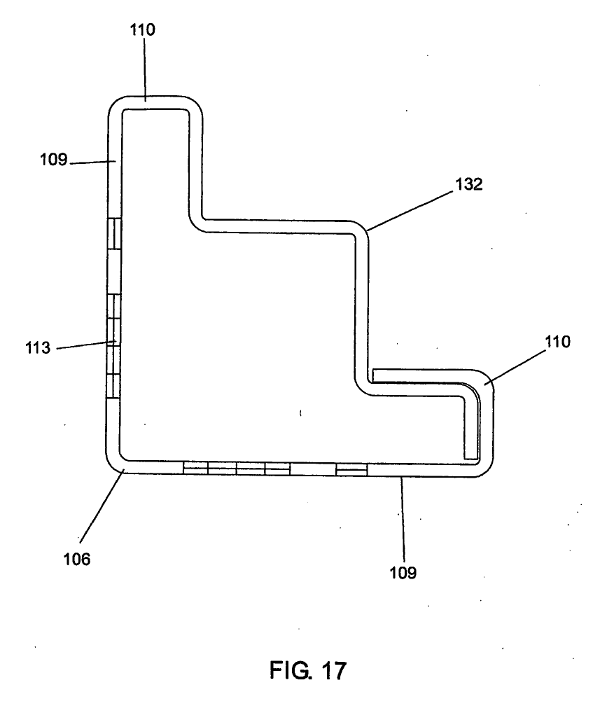

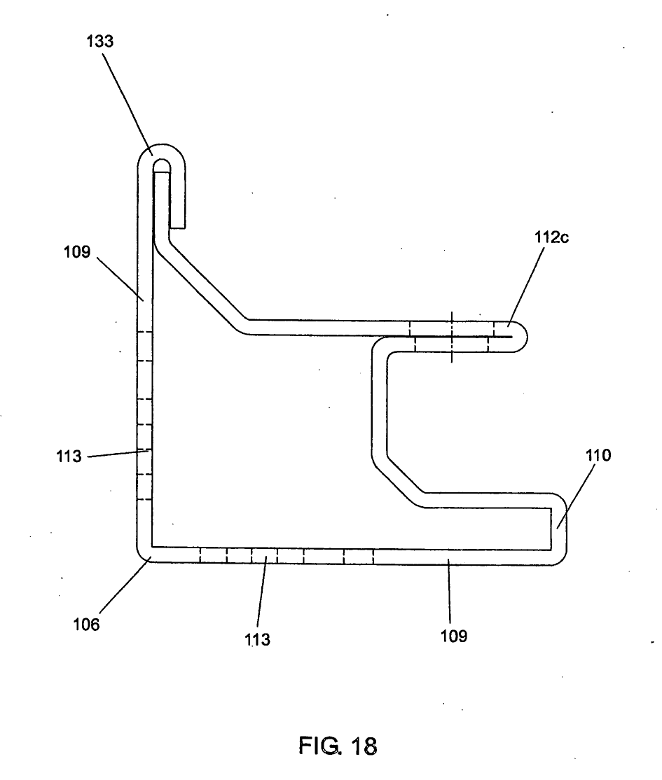

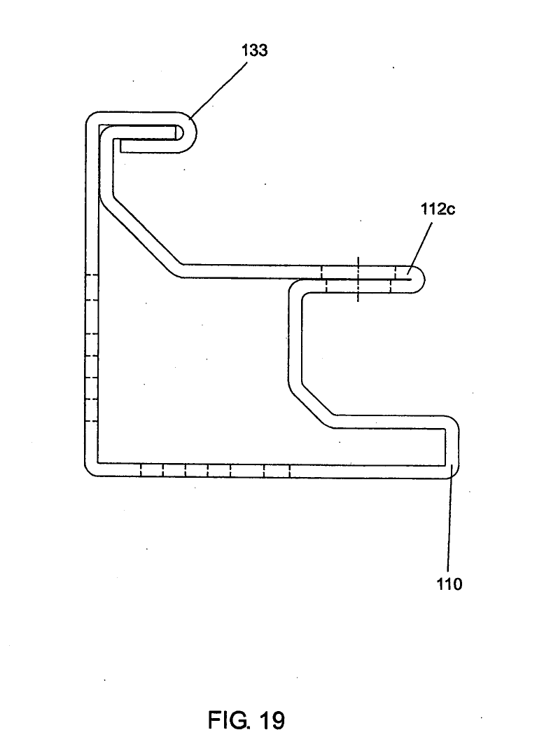

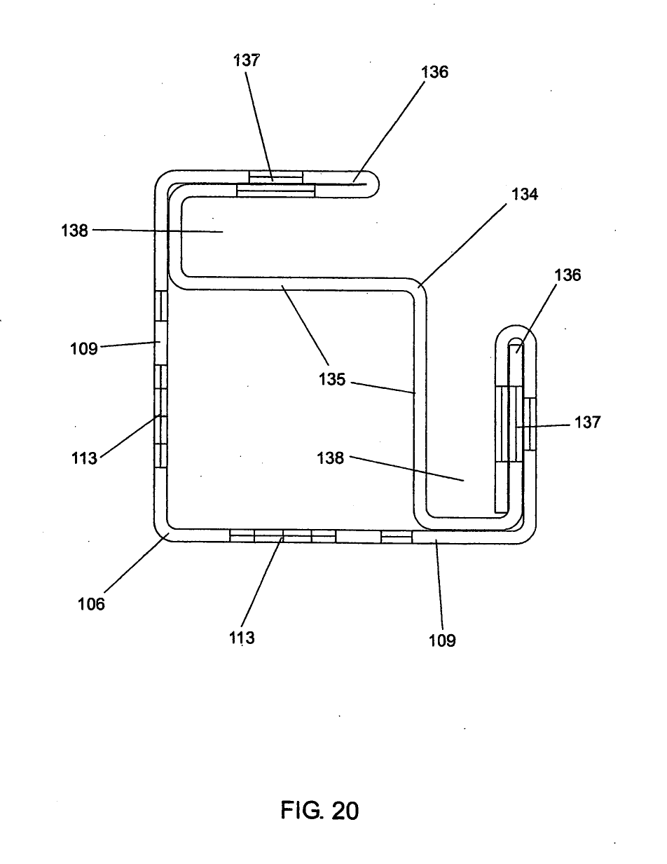

Still in relation to FIG. 3, logically and fundamentally any electrical panel must have an internal structure (103), which is substantially resistant to characterize a cabinet or closet suited to the equipment to be installed internally. This illustrated structure is obtained with the current cross section (104), seen with details in FIG. 4, through which it can be seen that it is characterized by the fact of presenting a transversal cross section with a new geometry, defined by a triangular rectangular shape, but its sides compete to form an internal section or central core in a tubular form (105), where the upright (106) (FIG. 5) is facing the inside of the cabinet (100), whilst the opposite upright (107) is facing the outside of the said cabinet (100), whilst the other two adjacent uprights (108) present a peculiar configuration, defined by the walls (109) which for the right angle (106), seeing that these walls to form each upright (108) are perpendicularly folded in direction to the upright (107) and, immediately thereafter again folded inwardly forming a ‘U’ top (110) and at the same time the stretches of walls (111) receive a succession of folds at different angles and sufficiently that these walls (111) may end up one against the other superimposed to form the upright (107), where the closure of the cross section takes place and at the same time, this upright extends itself outwardly and configures an assembly wing (112), which is flanked by the two walls (111), which besides being completely blind, remain outside the cabinet (100), which does not occur with the walls (109) which remain on the inside of the cabinet (100), as these distribute rows of openings and holes with varying dimensions and shapes (113), which constitutes fastening points for different components which are assembled inside the cabinet, which also happens with the assembly wing (112), where itself is punched with rows of variable holes and openings (114) for fastening external components to the cabinet (100).

Still in relation to FIG. 4, the uprights (108) and the upright (107), are at an inclined alignment, which corresponds to the diagonal in a hypotenuse manner opposite to straight upright (106).

The assembly wing (112) is positioned in a parallel manner in relation to one of the apexes (110); preferably this wing is also limited to within the external limit of the defined profile as defined by the uprights (108).

Looking at FIG. 5, it is noted that the uprights-(106) of the structure (103) remained facing the inside of the cabinet (100), which also happens with the openings (113), whilst on the other side of the cross section, that which is defined by upright (107), will remain facing to the outside of the cabinet (100) and, under this condition, due to the walls (111) being blind, there occurs a natural sealing between the internal environment of the cabinet and its exterior, considerably increasing the efficiency of the unit.

FIG. 5 gives a top view with a transversal cut of a basic cabinet obtained with the current profile and, in this figure, the sides were drawn exaggeratedly to better view the constructive details, but without this interfering in the construction of the details involved in the current improvement.

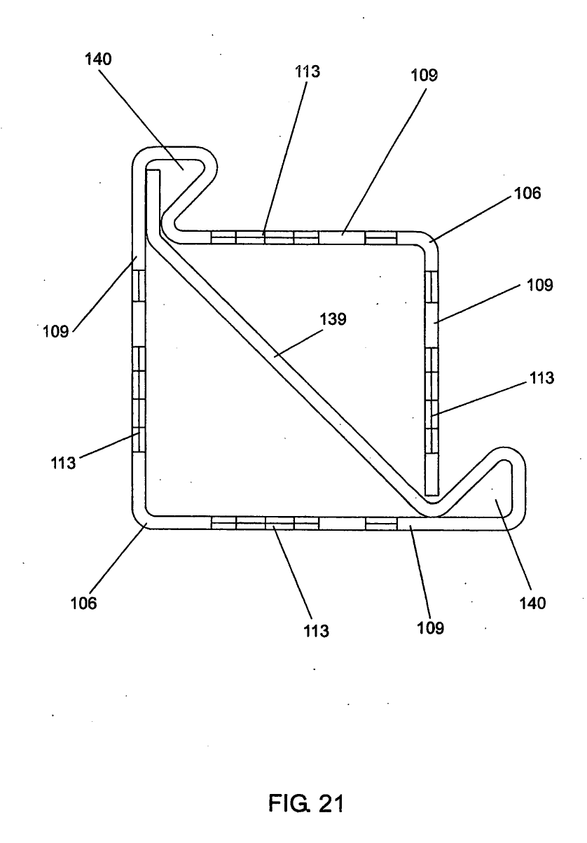

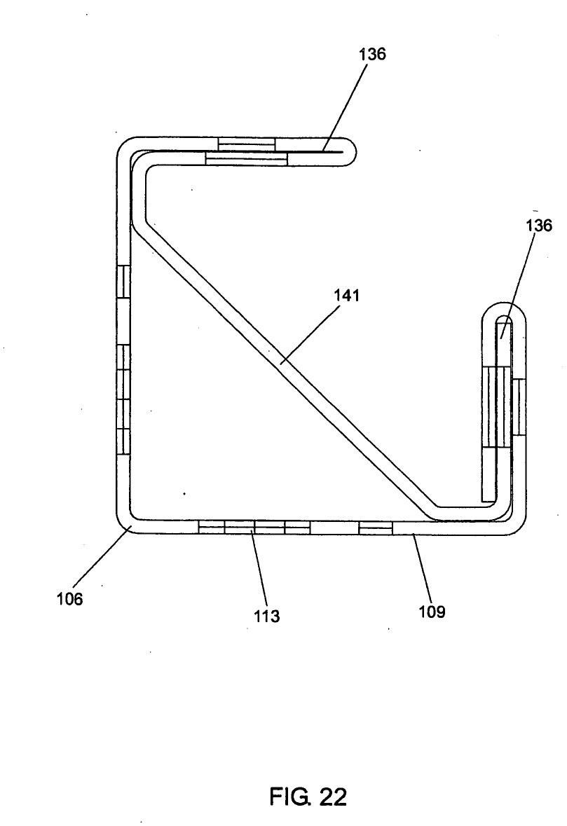

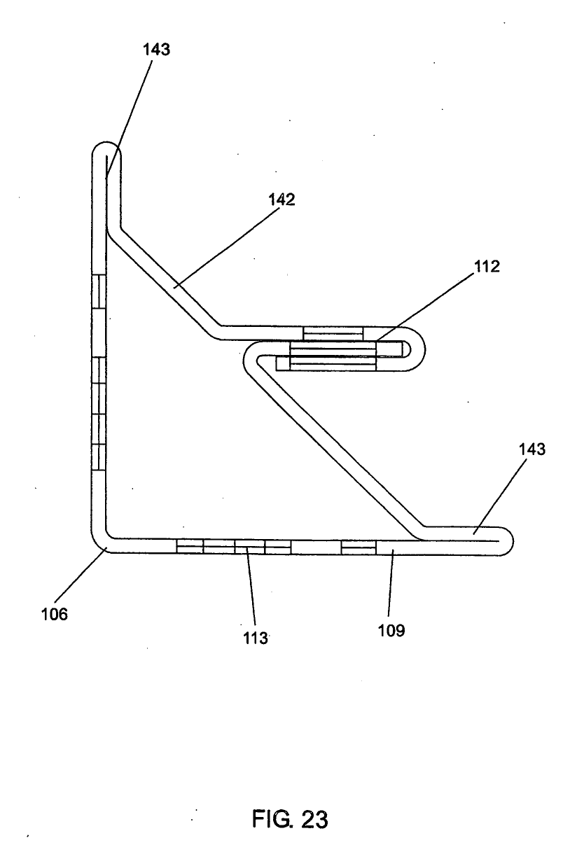

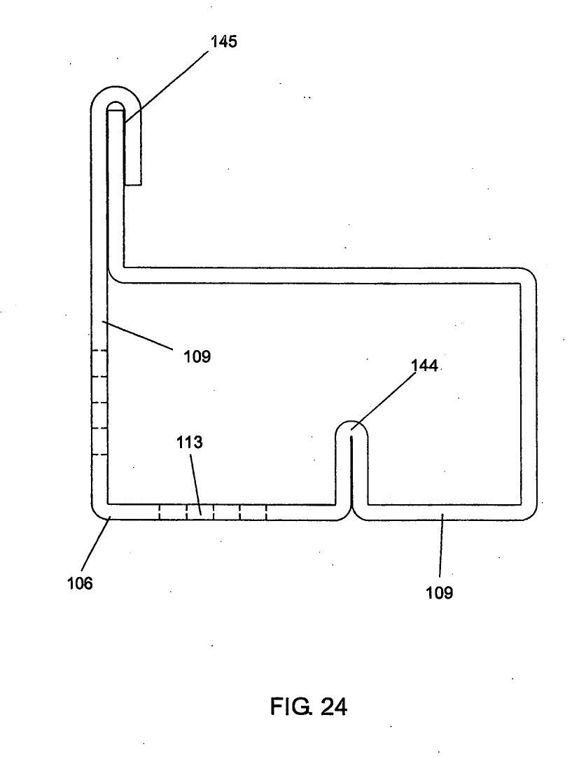

Looking at FIG. 6, we can see that another important characteristic of the cross section in question is obtained when a number of them are joined perpendicularly, to form a structure (103), that is when its ends are joined perpendicularly, the apexes (110) and the wing (112), as well as the other details of the cross section's geometry, remain facing the outside and combine to so that all the sides of the structure (103) are symmetrically equal, including the top side and bottom side, in such a way that these selfsame may (please see FIG. 5) receive the enclosures (101) and doors (102), whose fastenings are illustrated in FIGS. 7, 8 and 9, these details are amplified in FIG. 5.

As illustrated in FIG. 7, under a first usage condition the assembly wing (112), the same used for coupling and assembly of the enclosure panels (101), side and rear, being that for this end a spacer is used (115) which through its middle part is fastened (116) to the assembly wing, whilst its ends are folded in such a manner as to for parallel terminals (117) for receiving screws (118) which fasten the edges of the enclosing panels (101), pressuring it against the apexes (110) of the cross sections (104) where the sealing components are fitted (119), these find a suitable surface in the apexes (110) and consequently, achieve an excellent efficiency in sealing for the said enclosing panels (101).

In relation to FIGS. 8 and 9, it is noted that the geometry of the cross section in question favors assembly advantages of the hinged door (102) which on the one side has its hinge (120) fastened to the assembly wing (112), whilst on the opposite side (FIG. 9) it has its lock (121) and its locking components mounted on the other assembly wing (112), being that in this case the said hinged door (102) includes the sealing components (119) equally fitted against the apexes (110)

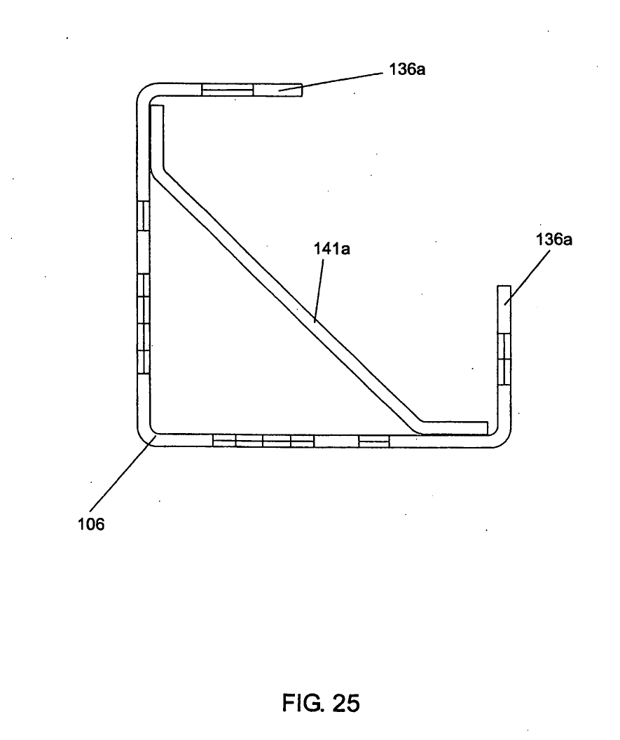

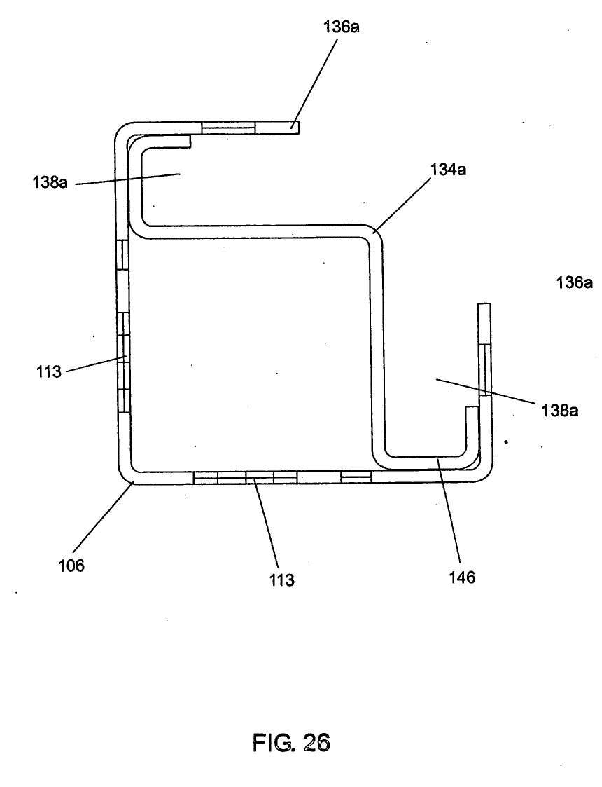

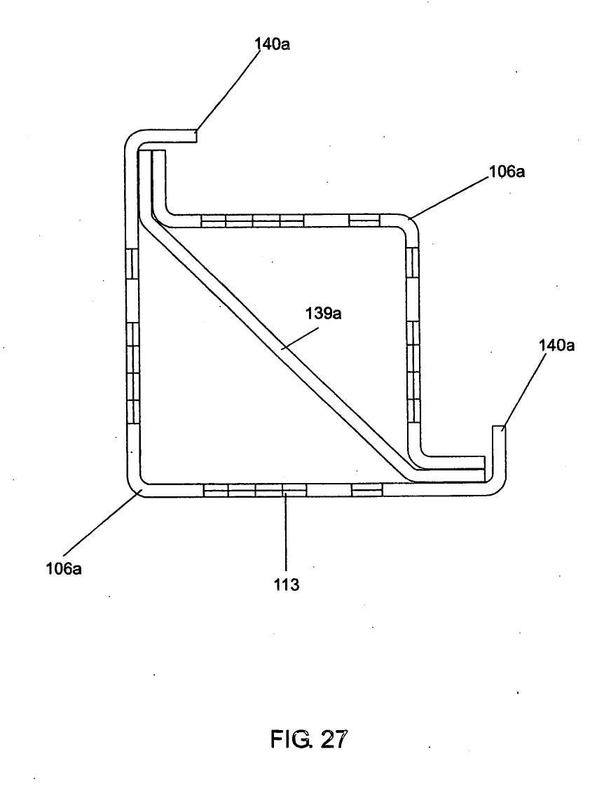

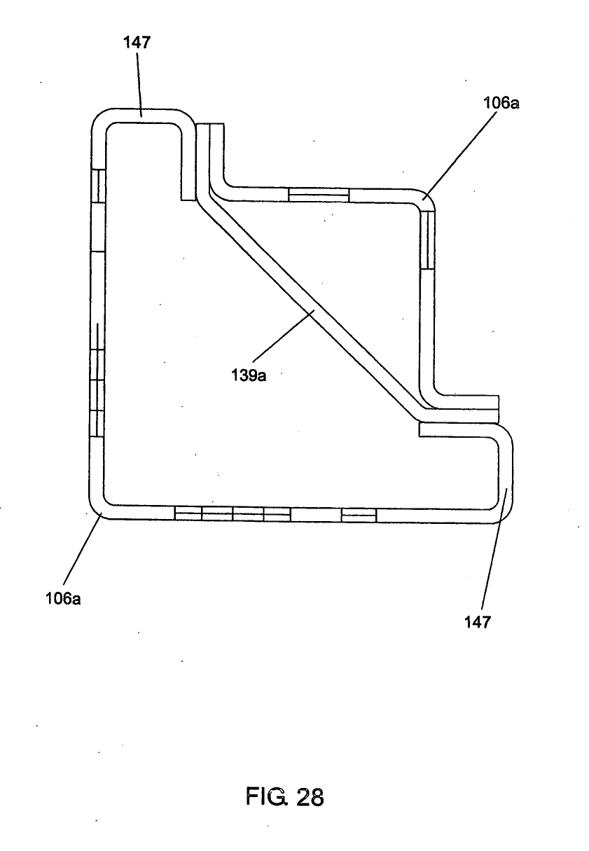

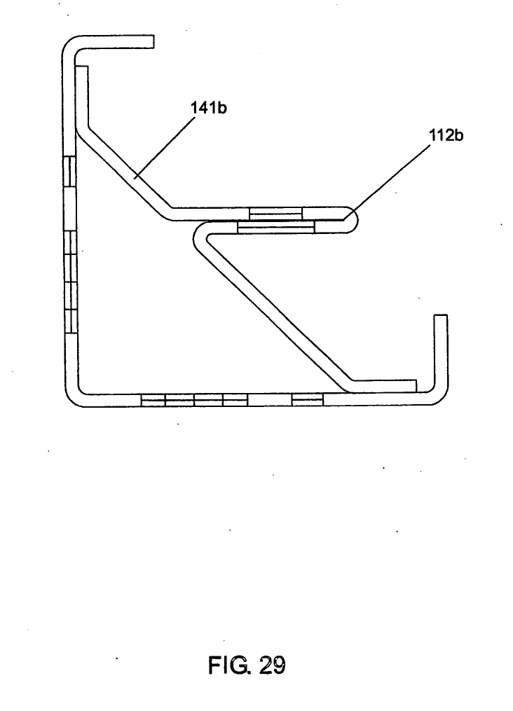

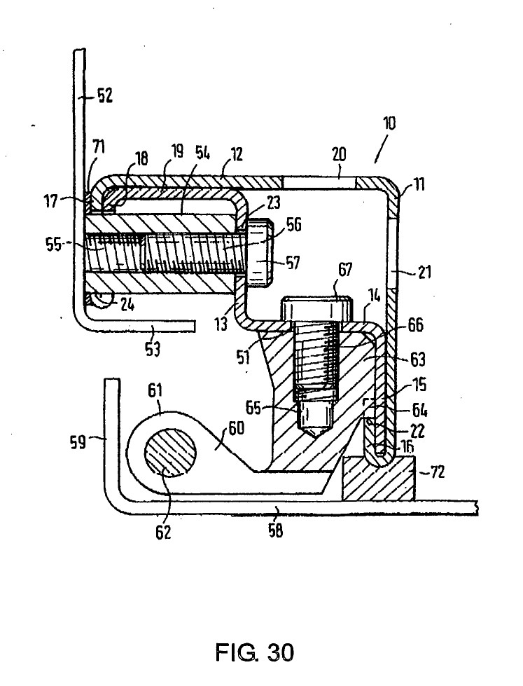

As has been said earlier, the current improved cross section affords the means of construction of a structure (103) whose sides are symmetrically equal, characterizing modular units as illustrated in FIG. 10. Under this condition it becomes possible for the interlinking between one unit and the other, being that for this end the cross section in question receives the compatible accessories for mechanical interlinking, as shown in the exploded view of FIG. 11, where all the components fit perfectly to the defined constructive details through the cross section's transversal geometry (104).

Therefore the cross section in question is also characterized by the fact of encompassing the mechanical components for side by side linkage between the various structures (103), starting with a “U” shaped join (123) whose ends besides being punched (124), also adjust themselves against the uprights (106) of two opposite cross sections (104) where the alignment between the openings takes place (124) and (113) to insert screws (125) and its respective nuts (126) positioned by clamps (127) on the inside of the cross section, being that, even the side by side joining of two cross section's results in the alignment and fitting of two apexes (110), between which a seal is fitted (128), which gives continuity to the insulation between the internal and external environments of the cabinet.

FIG. 12 shows the joining or coupling point of the front part between two structures of a cabinet, highlighting the assembly of the doors (102) and its respective hinges (120) and locks (121), s 8 and 9.

FIG. 13 shows the joining or coupling point of the rear between two structures of a cabinet, highlighting the assembly of the side enclosures (101), whose fastenings and seals occur in the same manner as described before and illustrated in FIG. 7.

FIG. 14 shows the joining or coupling point of the sides between two structures of a cabinet, highlighting the assembly of the rear enclosures (101), whose fastenings and seals occur in the same manner as described before and illustrated in FIG. 7.

Constructive Variations.

The FIGS. from 15 to 29 show some possible constructive variations to be adopted in the manufacture of the current profile, in such a manner that it may affect or service other objectives, nevertheless such variations are equally obtained starting from the main profile previously described and illustrated in FIG. 4.

FIG. (15) shows a constructive variation which is characterized by the fact that the assembly wing (112a) extends in conjunction with a right angled fold (129), nevertheless its position still continues parallel to one of the apexes (110) which in this version besides being shorter is also wider, as is also the case with the said wing (112a) which occurs in the closing of the cross section, that is three layers of sheets are superimposed. This constructive version besides increasing the structural effect of the cross section also affords an increase to the assembly area around the wing (112a), thus summing up the technical advantages and practices in relation to the profile shown in FIG. 4.

FIG. (16) shows another constructive variation and, in this case, the cross section is characterized by the fact that its diagonal wall (130) which interlinks the apexes (110) being practically straight and further, in its mid parts the two plates meet and face outwards this develops a wing for double assembly (112b), seeing that it is folded at a right angle in its mid-part (131), forming two stretches with openings (114), consequently this double wing besides increasing the structural effect of the unit, also offers a larger number of resources and a different assembly condition for the various components, so that the cross section may service the other market needs.

FIG. 17 shows another constructive variation and, in his case, the cross section preserves as in the previous ones the upright (106), the walls (109) with its openings (113) and the opposed apexes (110), but in this case the cross section is characterized by the fact that the apexes (110) are interlinked by a “W” wall in the form of a step, forming a right angle at the middle facing the outside (132), being that the enclosure of the cross section takes place on one of the apexes (110), where the superimposition of the extruded plate takes place.

FIG. 18 shows another constructive variation and, in this case, the cross section preserves as in the previous ones the upright (106), the walls (109) with its openings (113) and only one of the apexes (110), but in this case the cross section is characterized by the fact that one of the apexes (110) is substituted by a wing (133), coplanar to the wall (109), as well as another assembly wing is provided for (112c) positioned in parallel in relation to the apex (110), being also that in this case the enclosing of the cross section is done in the wing (133). This cross section is a simplified version and allows for the coupling of the structure only laterally (side by side).

FIG. 19 shows a practically equal cross section to that of FIG. (18), but in this case the cross section is characterized by the fact that the wing (133) is perpendicularly folded inwardly in parallel to the other wing (112c).

FIG. 20 shows another constructive variation and in this case the cross section preserves as in the previous ones the upright (106), the walls (109) with its openings (113), but this variation is characterized by the fact that that the opposed upright does not include an assembly wing, as well as its wall (135) completes a tubular square section, where the other two uprights have extensions forming wings (136) with openings (137), also as these wings remain positioned in parallel and removed from the walls (135), in such a way that between this and the said wing (136) a space is formed (138) and finally on one of the wings (136) the closing off of the cross section is achieved, as well as in this case the said wings (136) present a preferable length smaller than or equal to in relation to the corresponding wall (135).

FIG. 21 shows another constructive variation and in this case the cross section preserves as in the previous ones the upright (106), the walls (109) with its openings (113), being that in this case the cross section is characterized by the fact that it initially presents, in a symmetry with reference to the upright (106), seeing that the opposite side is equally formed by another upright (106) with openings (113) in its walls (109), being that between these two uprights (106) there exists a diagonal wall (139), having one end forming an ordinary triangular volute (140), which also occurs on the opposite side, but in this case the said volute imprisons the end of the wall (139) and defines the enclosing of the cross section, maintaining that sealed enclosure between the side of the cross section which is in the internal part of the cabinet and the side of the cross section which remains on the exterior of the cabinet.

FIG. 22 shows another constructive variation and in this case the cross section preserves a large part of the of the characteristics of the cross section as illustrated in FIG. 20, but in this case there is no upright (134), consequently this variation is characterized by the fact that between the wings (136) there exists a diagonal wall (141).

FIG. 23 shows another constructive variation and in this case the cross section is characterized by the fact that its triangular geometry is defined by the upright (106) and a diagonal wall (142) fitted with a wing to its mid region (112), where the enclosing of the cross section takes place, being that also the walls (109) with its openings (113) are interlinked to the walls (142) in such away as to form double walled end wings (143).

FIG. 24 shows another constructive variation and in this case the cross section presents a quadrangular transversal section preserving the upright (106) and openings, where one of the walls (109) presents an inward fold forming a double walled wing (144) and, still the other wall (109) extends itself outwardly forming another wing (145), where the enclosing of the cross section takes place.

As has already been seen the cross section in question described in the previous figures are all obtained by extrusion, that is a single sheet is extruded until it achieves the shape of the transversal cross section.

FIGS. 25 to 29 shows that the cross section in question is also characterized by the fact that its transversal geometry is defined by two or more independent cross section's, folded from sheets welded to one another, that is in FIG. 25 the illustrated cross section presents a geometry practically the same as the cross section in FIG. 22, nevertheless in this case it is characterized by the fact that its diagonal wall (141a) is an independent sheet, whose ends are welded against the wall (109) that in its turn has wings (136a) with single walls.

FIG. (26) shows a cross section with the same geometry as the cross section illustrated in FIG. 20, but in this case it is characterized by the fact that the internal part of the upright (134a) is a part independent to the wings (136a) being the only wall, maintaining the spacing (138a) an din this stretch the entire welded part has its ends folded in a “U” (146).

FIG. (27) shows a cross section with practically the same geometry as the cross section illustrated in FIG. 21, but in this case it is characterized by the fact that this is obtained by three independent parts, folded and assembled with welds at strategic points, being that one part forms the diagonal wall (139a), whilst the other two parts form the opposing uprights (106a), with both its walls (109a) punched with variable openings (113a), being that on two of the uprights all the ends of the three parts present superimposed stretches, closing the cross section and within these uprights with superimposed layers, one of the parts has its ends folded forming a wing shaped like an L (140a), thus finalizing a cross section equally impervious seeing that the wall (139a) is blind.

FIG. (28) shows a cross section with practically the same geometry as the cross section illustrated in FIG. 27, but in this case it is characterized by the fact that two of the opposing uprights are formed by their apexes folded in a “U” (147), to which the ends of the parts which forming the diagonal wall are fastened (139a) and one of the uprights (106a).

FIG. (29) shows a cross section with practically the same geometry as the cross section illustrated in FIG. 25, but in this case it is characterized by the fact that, besides being constructed with a pair of welded parts, to the diagonal wall (141b) includes an assembly wing (112b).

Logically the cross section obtained with two folded and welded sheets, is able to absorb the geometric shapes of the other constructive variations in such a way that the cross section is able to vary according to the applications of each project.

According to that which has been shown and illustrated, it is noted that the cross section in question and its accessories as well as its constructive variations, allows it to be used in the manufacture of indoor cabinet structures in general, notably for electrical panels, of the indoor or outdoor type, but nothing prevents it from being used in other similar applications as has already been said with the cross section in question it is possible to make up a structure, which in the end are uprights and cross members with fastening points for components, boards, devices, equipment and/or others. Under this condition the same cross section may be used for other applications different to electrical panels, without this requiring changes to its construction in its constructive variations.

On the other hand with the cross section in question all the previously mentioned advantages are achieved with ease, not only due to the fact of the new transversal geometry adopted for the cross section but also due to the fact that the said geometry was developed so that at the end it could have a perfect balance for the assembly of different external components, such as enclosures and doors, whose fastening points remain positioned on the outside of the cross section, whilst in its interior openings are provided for the assembly of equipment inside the cabinet or closet and with this the natural sealing of the cross section is maintained intact

1) IMPROVEMENT TO METALLIC CROSS SECTION FOR THE MAKE UP OF STRUCTURES FOR THE ASSEMBLY OF ELECTRICAL PANELS, this cross section was particularly developed for the assembly of indoor electrical cabinets or booths (100), defined by side enclosures (101), including one or more hinged doors (102), these and previous ones are made from substantially thin metallic sheets, which requires the use of a structure (103) of metallic cross section's (104), which constitutes the means for supporting the walls which make up the external walls out of folded sheet metal, as well as constituting the means for supporting the respective doors and hinges, as well as the other accessories, and still in this same structure, although on the inside also configures the necessary uprights for the distribution and assembly of the different electrical and electronic components and devices; characterized by the fact that the said cross section (104) presents a transversal cross section with a defined geometry in a triangular rectangular format, but its side compete to form an internal section or central core in a tubular form (105), where the upright (106) faces the inside of the cabinet (100), whilst the opposite upright (107) faces the outside of the said cabinet (100), whilst the other two adjacent uprights (108) present a peculiar configuration defined by the walls (109) which form a aright angle (106), no seen that for these walls to form each upright (108) are perpendicularly folded in the direction of the upright (107) and immediately thereafter again folded inwards forming an apex in a the shape of a “U” (110) and, at the same time the stretches of walls (111) receive a succession of folds at different angles and sufficiently so that these walls (111) may end one against the other superimposing on one another so as to form the upright (107), where the closing of the cross section takes place and at the same time this upright extends outwardly and configures an assembly wing (112), which is flanked by the two walls (111) which besides being completely blind, remain outside the cabinet (100), which does not occur with the walls (109) which remain inside the cabinet (100), as these distribute rows of openings and holes with variable shapes and sizes (113), these constitute the fastening points for the different components which are mounted in the interior of the cabinet, which also happens with the mounting wing (112), where it is itself punched by rows of variable openings and holes (114) for fastening the external components to the cabinet (100).

2) IMPROVEMENT TO THE METALLIC CROSS SECTION FOR THE MAKING UP OF STRUCTURES FOR THE ASSEMBLY OF ELECTRICAL PANELS, according to justification 1, characterized by the fact that the uprights (108) and the upright (107), are at an inclined alignment which corresponds to the diagonal as an opposing hypotenuse to the straight upright (106).

3) IMPROVEMENT TO THE METALLIC CROSS SECTION FOR THE MAKING UP OF STRUCTURES FOR THE ASSEMBLY OF ELECTRICAL PANELS, according to justification 1, characterized by the fact that the mounting wing (112) is positioned in a parallel manner in relation to one of the apexes (110), as well as this wing being preferably limited within the external limit of the cross section as defined by the uprights (108).

4) IMPROVEMENT TO THE METALLIC CROSS SECTION FOR THE MAKING UP OF STRUCTURES FOR THE ASSEMBLY OF ELECTRICAL PANELS, according to justification 1, characterized by the fact that, in another constructive variation the mounting wing (112a) extends itself in conjunction with a fold at right angles (129), nevertheless its positioning still continues parallel with one of the apexes (110) which in this version, besides being much shorter, but also wider, as in this case the wing itself (112a) the closing off of the cross section takes place, that is, there are three layers of superimposed sheet steel.

5) IMPROVEMENT TO THE METALLIC CROSS SECTION FOR THE MAKING UP OF STRUCTURES FOR THE ASSEMBLY OF ELECTRICAL PANELS, according to justification 1, characterized by the fact that, in another constructive variation the diagonal wall (130) which interlinks the two apexes (110) are practically straight and in its mid parts the two steel sheet are joined and face outwards, a double mounting wing is developed (112b), seeing that it is folded at right angles in the middle (131), forming two stretches with openings (114).

6) IMPROVEMENT TO THE METALLIC CROSS SECTION FOR THE MAKING UP OF STRUCTURES FOR THE ASSEMBLY OF ELECTRICAL PANELS, according to justification 1, characterized by the fact that, in another constructive variation the, two apexes (110) are interlinked by a “W” wall in a stepped manner, forming an outwardly facing median straight angle (132), being that the closing off of the cross section occurs on one of the apexes (110), where the superimposition of the extruded sheet takes place.

7) IMPROVEMENT TO THE METALLIC CROSS SECTION FOR THE MAKING UP OF STRUCTURES FOR THE ASSEMBLY OF ELECTRICAL PANELS, according to justification 1, characterized by the fact that, in another constructive variation, one of the apexes (110) is substituted by a wing (133), coplanar to the wall (109), as well as another mounting wing being provided for (112c) positioned in parallel in relation to the apex (110), being that even in this case the enclosing of the cross section is carried out on the wing (133).

8) IMPROVEMENT TO THE METALLIC CROSS SECTION FOR THE MAKING UP OF STRUCTURES FOR THE ASSEMBLY OF ELECTRICAL PANELS, according to justification 7, characterized by the fact that, in another constructive variation, the wing (133) is folded perpendicularly inwards and in a condition which is parallel to the other wing (112c).

9) IMPROVEMENT TO THE METALLIC CROSS SECTION FOR THE MAKING UP OF STRUCTURES FOR THE ASSEMBLY OF ELECTRICAL PANELS, according to justification 1, characterized by the fact that, in another constructive variation, the opposing upright does not include a mounting wing, as well as its wing (135) completes a square tubular section, where the other two uprights have extensions forming the wings (136) with openings (137), as well as these wings remaining apart from the walls in parallel (135), in such a manner that between this and the said wing (136) a space is formed (138) and also on one of the wings (136) the closing off of the cross section is carried out,

10) IMPROVEMENT TO THE METALLIC CROSS SECTION FOR THE MAKING UP OF STRUCTURES FOR THE ASSEMBLY OF ELECTRICAL PANELS, according to justification 9, characterized by the fact that the wings (136) preferably have its length smaller than or equal to in relation to the length of the corresponding wall (135).

11) IMPROVEMENT TO THE METALLIC CROSS SECTION FOR THE MAKING UP OF STRUCTURES FOR THE ASSEMBLY OF ELECTRICAL PANELS, according to justification 1, characterized by the fact that, in another constructive variation, presents two symmetrical uprights (106), which on the opposite side is equally formed by another upright (106) with openings (113) on two of its walls (109), being that between these two uprights (106) there exists a diagonal wall (139), having its one end forming an ordinarily triangular volute (140), which also happens on the opposite side, therefore in this case the said volute imprisons the extremity of the wall (139) which in its turn defines the impervious enclosure of the cross section or forms a sealed wall against the side of the cross section which remains in the internal part of the cabinet and the side of the cross section which remains on the outside of the cabinet.

12) IMPROVEMENT TO THE METALLIC CROSS SECTION FOR THE MAKING UP OF STRUCTURES FOR THE ASSEMBLY OF ELECTRICAL PANELS, according to justification 9, characterized by the fact that, in another constructive variation the upright (134) is substituted by a diagonal wall (141) whose ends form the wings (136).

13) IMPROVEMENT TO THE METALLIC CROSS SECTION FOR THE MAKING UP OF STRUCTURES FOR THE ASSEMBLY OF ELECTRICAL PANELS, according to justification 1, characterized by the fact that, in another constructive variation, its triangular geometry is defined by the upright (106) and a diagonal wall (142) medially fitted with a wing (112), where the cross section is closed, being that also these walls (109) with its openings (113) are interlinked to the wall (142) in such a way as to for extreme wings with a double wall (143).

14) IMPROVEMENT TO THE METALLIC CROSS SECTION FOR THE MAKING UP OF STRUCTURES FOR THE ASSEMBLY OF ELECTRICAL PANELS, according to justification 1, characterized by the fact that, in another constructive variation, it presents a quadrangular transversal section preserving the upright (106) and openings, where one of the walls (109) present an inwardly facing fold forming a double walled wing (144) and still the other wall (109) extends itself outwardly forming another wing (145), where the closing off of the cross section occurs.

15) IMPROVEMENT TO THE METALLIC CROSS SECTION FOR THE MAKING UP OF STRUCTURES FOR THE ASSEMBLY OF ELECTRICAL PANELS, according to justification 1, where the transversal geometry of the cross section is defined by two or more independently folded cross section's from welded sheet steel one to the other, characterized by the fact that in another constructive variation its diagonal wall (141a) is an independent piece of sheet steel, whose ends are welded against the walls (109) which, in its turn, present the wings (136a) with single walls.

16) IMPROVEMENT TO THE METALLIC CROSS SECTION FOR THE MAKING UP OF STRUCTURES FOR THE ASSEMBLY OF ELECTRICAL PANELS, according to justification 1, characterized by the fact that, in another constructive variation, the internal part of the upright (134a) is an independent part and the wings (136a) are single walled, maintaining the spacing (138a) and, in this stretch, the welded internal part presents its ends folded in a “U” (146).

17) IMPROVEMENT TO THE METALLIC CROSS SECTION FOR THE MAKING UP OF STRUCTURES FOR THE ASSEMBLY OF ELECTRICAL PANELS, according to justification 1, characterized by the fact that, in another constructive variation, is obtained with three independent parts, individually folded and assembled with welds at strategic points, being that one part forms a diagonal wall (139a), whilst the other two parts form the opposing uprights (106a), both of them with its wall (109a) punched with variable openings (113a), being that in of the two uprights all the ends of the three parts present superimposed stretches, closing the cross section and still with these uprights with the superimposed layers, one of the parts has one of its ends folded forming an L shaped wing (140a).

18) IMPROVEMENT TO THE METALLIC CROSS SECTION FOR THE MAKING UP OF STRUCTURES FOR THE ASSEMBLY OF ELECTRICAL PANELS, according to justification 1, characterized by the fact that, in another constructive variation, two of the opposing uprights are formed by their apexes folded in a “U” (147), to which the ends of the parts are fastened forming a diagonal wall (139a) in one of the uprights (106a).

19) IMPROVEMENT TO THE METALLIC CROSS SECTION FOR THE MAKING UP OF STRUCTURES FOR THE ASSEMBLY OF ELECTRICAL PANELS, according to justification 1, characterized by the fact that, in another constructive variation, besides being constructed from two welded, the diagonal wall (141b) includes a mounting wing (112b).
